(19) United States
(12) Patent Application Publication
(10) Pub. No.: US 2026/0054506 A1
(43) Pub. Date: Feb. 26, 2026

(54) RECORDING APPARATUS

(71) Applicant: CANON KABUSHIKI KAISHA, Tokyo (JP)

(72) Inventor: ERIKA OISHI, Kanagawa (JP)

(21) Appl. No.: 19/298,606

(22) Filed: Aug. 13, 2025

(30) Foreign Application Priority Data
Aug. 21, 2024 (JP) 2024-139731
Jul. 2, 2025 (JP) 2025-112313

(51) Int. Cl. B41J 11/00; B41J 15/04; B41J 29/393

(52) U.S. Cl. CPC B41J 11/008; B41J 11/0095; B41J 15/048; B41J 29/393

(57) ABSTRACT

Used is a recording apparatus recording an image onto a recording medium wound as a roll, including: a conveying unit which conveys the recording medium; a recording unit disposed along a conveying path and records an image onto the recording medium; a take-up unit which winds the recording medium; and a control unit which executes first control of momentarily interrupting recording after starting recording of the image without having a leading end of the recording medium attached to the take-up unit, with the leading end of a recorded image recorded on the recording medium having reached a predetermined position in the conveying path, and second control of continuing the recording when the leading end of the recorded image has reached the predetermined position, with the leading end of the recording medium being attached to the take-up unit.

### BACKGROUND

### Field of the Technology

The present disclosure relates to a recording apparatus.

### Description of the Related Art

Some recording apparatuses (printers) for recording images, characters, and the like onto a sheet include an apparatus for winding the sheet after finishing printing. For a take-up apparatus to wind a sheet, the leading end of the sheet needs to be attached to the apparatus. However, if the leading end of the sheet is attached to the take-up apparatus before starting printing, printing cannot be performed onto the leading end of the sheet, and the sheet is consumed wastefully.

In order to overcome this challenge, there has been a recording apparatus allowing a user to attach the leading end of a sheet to a take-up apparatus while the printing is being executed. However, because the printing operation itself does not stop, the timing for attaching the leading end becomes critical, and the user is required to have the skill therefor. In relation to such a point, Japanese Patent Application Laid-open No. 2016-107526 addresses the issue by interrupting printing at the timing when the leading end of the sheet comes near the take-up apparatus, and prompting the user to attach the leading end to the take-up apparatus.

### SUMMARY

The present disclosure provides a recording apparatus recording an image onto a recording medium wound as a roll, the recording apparatus comprising:
a conveying unit configured to convey, along a conveying path, the recording medium pulled out from the roll;
a recording unit disposed along the conveying path and configured to record an image onto the recording medium;
a take-up unit configured to wind the recording medium onto which the image has been recorded; and
a control unit configured to execute first control of momentarily interrupting recording after starting recording of the image without having a leading end of the recording medium attached to the take-up unit, with a leading end of a recorded image on the recording medium having reached a predetermined position in the conveying path, and second control of continuing the recording when the leading end of the recorded image on the recording medium has reached the predetermined position, with the leading end of the recording medium having attached to the take-up unit.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic diagram illustrating a relationship between a recording apparatus and externally connected devices in an embodiment.

FIG. 2 is a block diagram illustrating a configuration of the recording apparatus in the embodiment.

FIG. 3 is a perspective view illustrating a configuration of the recording apparatus in the embodiment.

FIG. 4 is another perspective view illustrating the configuration of the recording apparatus in the embodiment.

FIG. 5 is a schematic diagram illustrating a cross section of a sheet conveying structure of the recording apparatus in the embodiment.

FIG. 6 is another schematic diagram illustrating a cross section of the sheet conveying structure of the recording apparatus in the embodiment.

FIGS. 7A to 7C are schematics for explaining a spool member to which a roll sheet R is attached in the embodiment.

FIG. 8 is a flowchart illustrating a process after printing is started in the embodiment.

FIG. 9 is another flowchart illustrating the process after printing is started in the embodiment.

FIG. 10 is a schematic illustrating an example of a display screen prompting a user to attach the sheet in the embodiment.

FIG. 11 is a schematic illustrating an example of a display screen after a user has attached in the embodiment.

FIG. 12 illustrates an example of a screen in which a user makes an input as to whether the sheet has been attached in the embodiment.

### DESCRIPTION OF THE EMBODIMENTS

An embodiment of the present disclosure will now be described with reference to drawings. However, it is to be understood that dimensions, materials, shapes, relative arrangements, and the like of components described in the following embodiment are intended to be changed as appropriate, in a manner suitable for configurations and various conditions of devices to which the present disclosure is applied. Therefore, the embodiment is not intended to limit the scope of the present disclosure in any way, unless where specified otherwise. While a plurality of features are described in the embodiment, not all of the plurality of features are essential to the present disclosure, and the plurality of features may be combined in any way.

According to research conducted by the inventors of the present disclosure, conventional recording apparatuses are incapable of determining whether a sheet is attached to the take-up apparatus. Therefore, printing may be interrupted even when a sheet has already been attached to the take-up apparatus, and the resultant printout may have image defects such as color unevenness. Hence, in the recording apparatuses including a take-up apparatus configured to wind a sheet by having the leading end of the sheet attached thereto, there is a demand for measures for preventing image defects caused by such interruptions in image recording.

### Embodiment

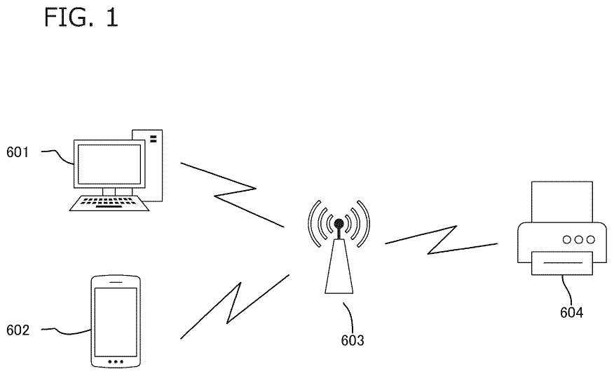

FIG. 1 is a schematic diagram illustrating a relationship between a recording apparatus 604 (printer) and externally connected devices in the embodiment. The recording apparatus 604 is connected to the externally connected devices via a LAN unit 603. The LAN unit 603 connects the recording apparatus 604 to a server via an interface or a network, for example. For an externally connected device such as a personal computer 601 or a smartphone 602 to transfer image data to the recording apparatus 604, for example, the image data is transferred via the LAN unit 603. The communication method used by the LAN unit 603 is not limited to a particular method, and may be wired or wireless communication as long as data can be transmitted and received.

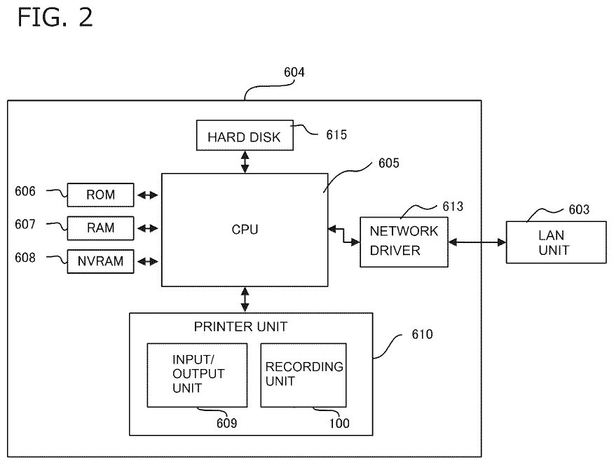

FIG. 2 is a block diagram illustrating a configuration of the recording apparatus 604 in the embodiment. The recording apparatus 604 is controlled by a CPU 605 that is a control unit, and has a printer unit 610 for printing. The printer unit 610 includes an input/output unit 609 that has a user interface such as an LCD, an LED, a key, or a touch panel, and a recording unit 100 that executes printing by recording an image on a recording medium.

A ROM 606 stores therein a control execution code (program) for the recording apparatus. The RAM 607 stores therein image data to be printed, as a temporary storage during the execution of the control of the recording apparatus 604. An NVRAM 608 is a non-volatile memory and stores therein various types of data required in the maintenance of the recording apparatus and information related to the image to be printed.

A hard disk 615 stores therein image data to be printed by the printer unit 610. A network driver 613 exchanges execution instructions and data with externally connected devices and the server via the LAN unit 603. For example, when printing is to be executed by the printer unit 610, image data is transferred from the externally connected device via the network driver 613.

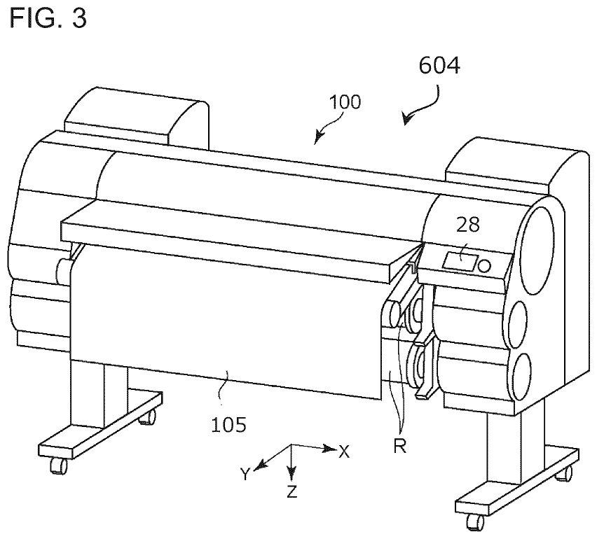

FIG. 3 is a perspective view illustrating a configuration of the recording unit 100 in the recording apparatus 604 in the embodiment. The recording unit 100 can hold two roll sheets R, each of which is a sheet 105 wound around a roll core, as a roll. Note that the number of roll sheets R the recording unit 100 can hold is not limited to two, but may be one, or three or more.

An operation panel 28 is an interface module that receives various operations from a user. A user can execute various settings for the recording unit 100, using various switches provided to the operation panel 28.

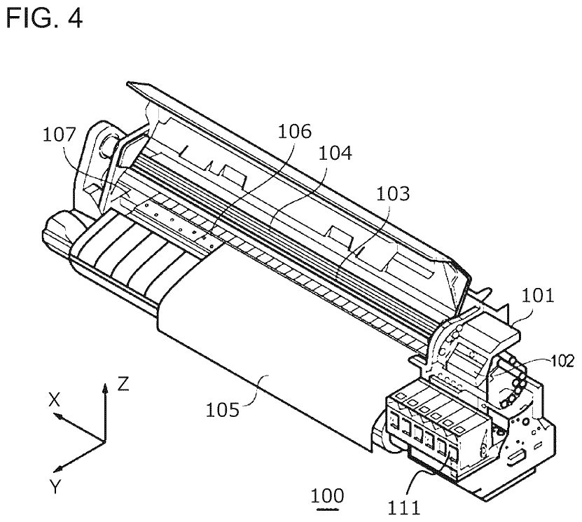

FIG. 4 is another perspective view illustrating the configuration of the recording unit 100 in the embodiment. The recording unit 100 is an ink-jet recording apparatus that performs recording by applying ink droplets as a recording material onto a recording medium such as paper. A sheet 105, which is a recording medium, is conveyed in the Y direction. A carriage 101 carrying a recording head 102 perform recording by reciprocating in an X direction intersecting with a Y direction. In other words, the recording unit 100 according to this embodiment is an ink-jet recording apparatus having what is called a serial recording head. However, it is also possible to use an ink-jet recording apparatus having what is called a linear recording head, in which a row of nozzles is provided across a recording width along the Y-direction. The recording unit 100 may also be a multi-function peripheral (MFP) in which a scan function, a fax function, a transmission function, as well as the recording function, are integrated. The recording unit 100 may also be a recording apparatus based on an electrophotographic system using a powder toner as a recording material. The material of which the recording medium is made is not limited to paper, and may be vinyl or fabric, for example. Regardless of the material of the recording medium, the technique according to the present disclosure is applicable as long as the recording medium is a sheet on which an image can be recorded by the recording unit 100 according to this embodiment.

In this embodiment, the recording unit 100 has a function of an information processing apparatus for determining a sheet 105 to be used, as will be described later. Such information processing may also be executed by the CPU 605 or the externally connected device.

The carriage 101 includes an optical sensor and a recording head 102. The recording head 102 is provided on the surface having nozzles through which the ink supplied from an ink tank 111 is ejected. The carriage 101 is configured reciprocally movable in the X direction (the direction in which the carriage moves) along a shaft 104, by being driven by a carriage motor via a carriage belt 103.

A sheet 105, such as a roll sheet or a cut sheet, is conveyed across a platen 106 by a conveying roller, in the Y direction. A recording operation is performed by causing the recording head 102 to eject ink droplets while the carriage 101 is moving in the X direction across the sheet 105, which has been conveyed onto the platen 106 by the conveying roller. When the carriage 101 moves to the end of the recording area of the sheet 105, the conveying roller conveys the sheet 105 by a predetermined amount, and moves the area where the next recording scan is to be performed to the position where the recording head 102 can perform recording. By repeating the operations described above, an image is recorded on the sheet 105.

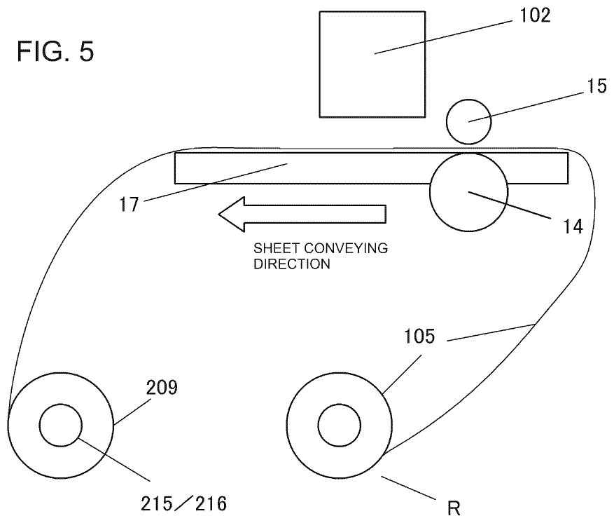

FIG. 5 is a schematic diagram illustrating a cross section of a sheet conveying structure of the recording apparatus 604 in this embodiment. This drawing illustrates the recording apparatus 604 with a sheet 105, which is a recording sheet, attached thereto. The sheet 105 is nipped between a conveying roller 14 and a nip roller 15 from above and below, respectively. As the conveying roller 14 is rotated, the sheet 105 is conveyed in a conveying direction (leftwards in this drawing). Among the sides of the path along which the sheet is conveyed, the side nearer to the roll sheet R will be referred to as an upstream side, and the side nearer to a sheet ejection port will be referred to as a downstream side. The sheet 105 is also supported by the platen 17 from below, in the area without the conveying roller 14.

The sheet 105 having an image recorded by the recording head 102 in the recording unit 100 is wound by a take-up apparatus 209 (take-up unit). To enable the take-up apparatus 209 to wind the sheet 105 after printing, it is necessary to attach the leading end of the sheet 105 to the take-up apparatus 209. Examples of means for attaching includes means for tape-fixing the leading end of the sheet 105 to the take-up apparatus 209, and means for clamping the leading end of the sheet 105 between attaching portions provided to the take-up apparatus 209.

The control unit determines whether the leading end of a sheet has been attached to the take-up apparatus 209. To make the determination, the control unit drives a take-up roll driving motor 215 to cause the take-up apparatus 209 to rotate in the direction in which the sheet is to be wound. A take-up encoder 216 is then caused to check whether the take-up apparatus 209 has been rotated only by an amount instructed by a drive command. If the take-up apparatus 209 has been driven by the amount instructed by the drive command, it can be determined that the leading end of the sheet has not been attached to the take-up apparatus 209. If the take-up apparatus 209 has not been driven by the amount instructed by the drive command, it can be determined that the leading end of the sheet has been attached to the take-up apparatus 209. Therefore, the leading end of the sheet needs to be attached to the take-up apparatus 209 strong enough so that the leading end of the sheet does not come off by being subjected to the driving force of the take-up roll driving motor 215.

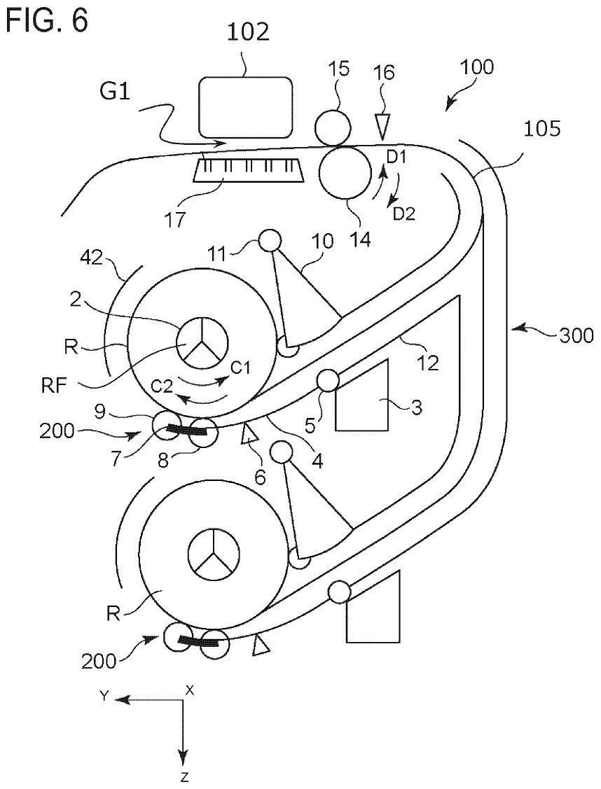

FIG. 6 is another schematic diagram illustrating a cross section of the sheet conveying structure of the recording unit 100 in the recording apparatus 604 in this embodiment. Two sheet feeders 200 each of which is capable of feeding a roll sheet R are disposed inside the recording unit 100. In this embodiment, the sheet feeders 200 are enabled to be used not only as a feeder unit but also as a take-up unit, but may also be capable of being used only as a feeder unit. It is also possible for the recording unit 100 to be provided with a structure only capable of being used as a take-up unit.

The sheet 105 pulled out from the roll sheet R by the sheet feeder 200 is conveyed by a sheet conveying unit 300 (conveying unit), and reaches an image recording region G1 (printing position), which is a position facing the recording head 102 on the platen 17. The sheet conveying unit 300 includes a conveying path and a conveying roller. The ink is then ejected, by the recording head 102, onto the sheet 105 having reached the image recording region G1, so that a desired image is formed on the sheet 105. The recording head 102 ejects ink through an ejection port using an ejection energy generating element. For example, when a thermoelectric conversion element is used as the ejection energy generating element, the recording head 102 forms a bubble in the ink, using the heat generated by the element, and ejects the ink through the ejection port. It is also possible to use any ejection energy generating element, such as a piezoelectric element, other than the thermoelectric conversion element.

When the serial recording head 102 is in use, a desired image is recorded by conveying the sheet 105 by a predetermined distance on the sheet conveying unit 300, and by then scanning the recording head 102 in a direction intersecting with the conveying direction of the sheet 105 (width direction). The sheet 105 having an image formed is then further conveyed, passes through a discharge port, and hangs down by its own weight.

A shaft-shaped spool member 2 is inserted into a hollow hole RF of the roll sheet R. The spool member 2 is driven in rotation in the direction of an arrow C1, and the direction of an arrow C2 by a roll driving motor, which will be described later. As a result, the roll sheet R rotates in the direction of the arrow C1 and the direction of the arrow C2, with the center thereof held by the spool member 2. The direction C1 is the direction opposite to the direction in which the sheet 105 is conveyed across the image recording region G1, which is the section facing the recording head 102. The direction C2 is the direction same as the direction in which the sheet 105 is conveyed across the image recording region G1, which is a section facing the recording head 102.

The sheet feeder 200 includes a drive member 3, an arm member 4, an arm rotating shaft 5, a first sheet sensor 6, a reciprocating member 7, driven rotating member 8 and 9, a separation flapper 10, and a flapper rotating shaft 11, as will be described later. In this embodiment, the driven rotating members 8 and 9 are not directly rotated by a motor or the like, but are rotated by receiving the rotation of the roll sheet R, as the roll sheet R is rotated.

A conveying guide 12 is a guide forming a path for guiding the sheet 105 pulled out of the roll of the sheet feeder 200 to the image recording region G1. The conveying guide 12 is configured to guide the bottom surface of the sheet 105, and the separation flapper 10 is configured to guide the top surface of the sheet 105. The conveying guide 12 and the separation flapper 10 together form an opening for the path via which the sheet 105 is guided to the image recording region G1. This opening is positioned below the center of a sheet tube mounted on the sheet feeder 200, in the gravity direction. The conveying roller 14 is rotated in the direction of an arrow D1 and the direction of an arrow D2 by a conveying roller driving motor, which will be described later. The nip roller 15 can be driven in rotation by the rotation of the conveying roller 14, in proximity that is near the conveying roller 14.

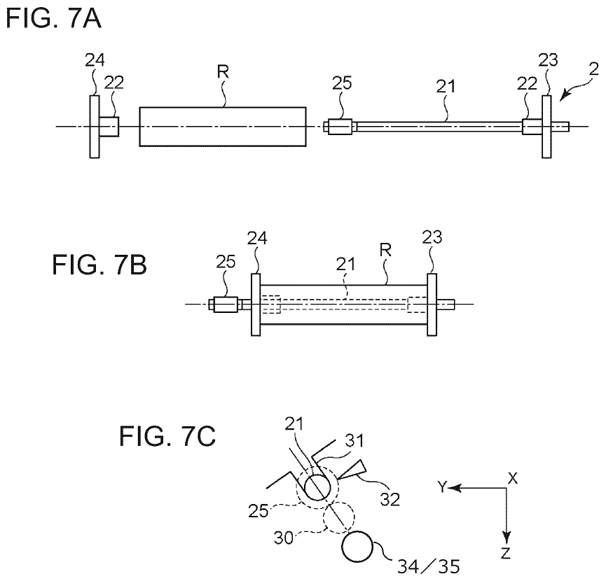

FIGS. 7A to 7C are schematics for explaining the spool member 2 to which the roll sheet R is attached in the embodiment. The spool member 2 includes a spool shaft 21, friction members 22, a reference-side spool flange 23, a non-reference-side spool flange 24, and a spool gear 25. One end of the spool shaft 21 is provided with the reference-side spool flange 23, and the other end is provided with the spool gear 25 for rotating the spool shaft 21. The reference-side spool flange 23 and the non-reference-side spool flange 24 are provided with the friction members 22, respectively.

When the roll sheet R is to be set on the spool member 2, to begin with, the non-reference-side spool flange 24, having been fitted onto the spool shaft 21, is removed. The spool shaft 21 is then inserted into the hollow hole RF inside the roll sheet R. The outer diameter of the spool shaft 21 is configured smaller than the inner diameter of the hollow hole RF. With this, a gap is formed between the spool shaft 21 and the roll sheet R, with the spool shaft 21 inserted into the hollow hole RF, so that a user can insert the spool shaft 21 into the hollow hole RF, without exerting much force.

As the spool shaft 21 is inserted into the hollow hole RF of the roll sheet R, the bottom of the roll sheet R on the right side in FIG. 7A comes into contact with the reference-side spool flange 23. At this time, the friction member 22 provided on the reference-side spool flange 23 is fitted into the hollow hole RF of the roll sheet R. As a result, the friction member 22 and the roll sheet R come into contact with each other and the gap between the spool shaft 21 and the roll sheet R is eliminated. In the manner described above, the spool shaft 21 and the roll sheet R can be fixed to each other.

The spool shaft 21 is then passed into the non-reference-side spool flange 24, and the friction member 22 provided on the inner side of the non-reference-side spool flange 24 is fitted into the hollow hole RF of the roll sheet R. As a result, the roll sheet R can be fixed by the reference-side spool flange 23 and the non-reference-side spool flange 24, so that the roll sheet R can be prevented from moving in lateral directions along the spool shaft 21. In the manner described above, the roll sheet R is attached to the spool member 2.

FIG. 7B is a schematic illustrating the spool member 2 with the roll sheet R attached thereto. By fitting both ends of the spool member 2 having the roll sheet R is attached thereto into spool holders 31 of the sheet feeder 200, respectively, the roll sheet R is completely set.

FIG. 7C is a side view illustrating the spool member 2 having both ends fitted into the spool holders 31. To attach a sheet tube to the spool member 2 to wind the sheet 105, the steps described above may be performed, using a sheet tube instead of the roll sheet R.

The sheet feeder 200 has the spool holders 31 at positions corresponding to the respective ends of the spool shaft 21. The inner surface of each of the spool holders 31 delineates a U shape, and a user can insert the end of the spool shaft 21 through the opening. With the spool member 2 fitted into the spool holders 31, the spool gear 25 is connected to a roll driving motor 34 via a drive gear 30 provided to the sheet feeder 200. The roll driving motor 34 has an encoder 35 attached thereto, so as to enable the amount of rotation of the motor to be measured. By causing the roll driving motor 34 to drive the roll sheet R with the spool member 2 in the forward direction, an operation of feeding the sheet 105 is executed and the sheet 105 is conveyed in the conveying direction. By driving the roll sheet R with the spool member 2 in the reverse direction, an operation of winding the sheet 105 can be achieved.

A roll sensor 32 detects the presence of the spool member 2. That is, the roll sensor 32 detects whether there is any spool member 2 at an attachment position of the spool member 2 in the sheet feeder 200.

### Processing Sequence

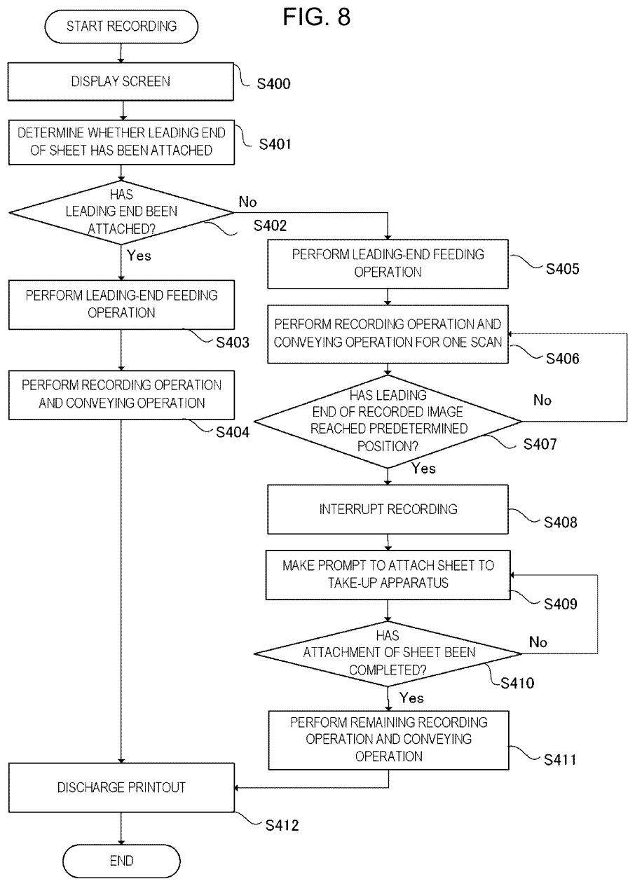

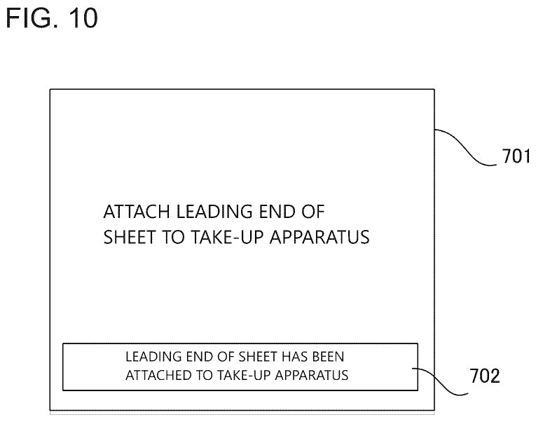

FIG. 8 is a flowchart illustrating a process after image recording is started in this embodiment. Upon receiving an image recording job, the recording apparatus 604 starts recording. At this time, if the sheet is of a specific type, or long printing is to be executed (e.g., when the sheet is of a type requiring winding), the image recording may fail unless the leading end of the sheet is attached to the take-up apparatus 209. Therefore, in step S400, the user is prompted to attach the sheet 105, by presenting a screen recommending the user to attach the leading end of the sheet to the take-up apparatus 209 before the recording is started, as illustrated in FIG. 10.

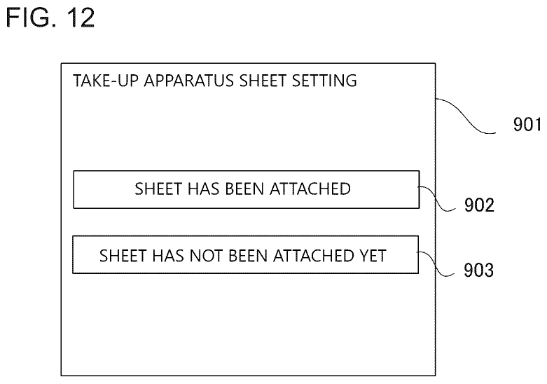

In step S401, processing for determining whether the leading end of the sheet has been attached to the take-up apparatus 209 is performed. For example, the take-up apparatus 209 is rotated to wind and to tighten the sheet 105 so as to generate tension, and the tension value is measured. In step S402, the CPU 605 compares the tension value with a predetermined threshold. If the tension value is equal to or greater than the threshold, determination is made that the leading end of the sheet has been attached to the take-up apparatus 209. If the tension value is less than the threshold value, determination is made that the leading end of the sheet has not been attached to the take-up apparatus 209. This criterion for the determination is, however, not limited thereto. Furthermore, this step may be skipped, when the sheet is of a specific type (e.g., when the sheet is of a type not requiring winding), so as to prevent the sheet 105 from stretching as the sheet 105 is wound and tightened. As another example, the user may enter whether the leading end of the sheet has been attached to the take-up apparatus 209 on an input screen, one example of which is illustrated in FIG. 12.

If the leading end of the sheet has been attached to the take-up apparatus 209 (Yes in S402), the process is shifted to step S403. In step S403, a leading-end feeding operation for conveying the leading end of the sheet to the position of the first scan is performed. In step S404, the recording operation and the conveying operation are then performed to the sheet 105 until the complete recorded image is achieved. Even when the leading end of the recorded image recorded on the sheet 105 has reached a predetermined position, the recording is continued without being interrupted. That is, scanning of the recording head and conveying of the sheet are continued. However, when a single recorded image is short, the leading end of the recorded image may not reach the predetermined position. In this case, multiple images are recorded based on one job or multiple jobs. In this case, the leading end of the recorded image may be defined as the leading end of the most downstream recorded image in the conveyance direction that was recorded first. Note that the amount of conveyance of the sheet 105 is measured by an encoder of the conveying roller 14. Also, the recorded image may include a margin at the leading end. When considering that the recorded image includes the margin at the leading end, the leading end of the recorded image becomes the leading end of the sheet. Furthermore, in step S404, after the cueing operation, if the sheet 105 has been conveyed by a predetermined conveyance amount, recording may be continued without temporarily pausing. The process is then shifted to step S412. Such control for continuing the recording when the leading end of the recorded image recorded on the sheet 105 reaches the predetermined position with the sheet 105 attached to the take-up apparatus 209 corresponds to second control performed by the CPU 605.

By contrast, if the leading end of the sheet has not been attached to the take-up apparatus 209 (No in S402), the process is shifted to step S405. In step S405, a leading-end feeding operation for conveying the sheet to the position of the first scan is performed. In step S406, a recording operation and a conveying operation corresponding to one scan are executed.

In step S407, it is determined whether the leading end of the recorded image recorded on the sheet has reached the predetermined position. However, when a single recorded image is short, the leading end of the recorded image may not reach the predetermined position. In this case, multiple images are recorded based on one job or multiple jobs. The leading end of the recorded image in this case may be defined as the leading end of the most downstream recorded image in the conveyance direction that was recorded first. Note that the amount of conveyance of the sheet 105 is measured by an encoder of the conveying roller 14. Additionally, the recorded image may include a margin at the leading end. Therefore, the leading end of the recorded image becomes the leading end of the sheet. Furthermore, in step S407, it may be determined whether the sheet 105 has been conveyed by a predetermined conveyance amount after the cueing operation. Assumed as the predetermined position is the position where the take-up apparatus 209 is installed, for example. Typically, the predetermined position is a position where the leading end of the sheet is close enough to the take-up apparatus 209 for the user to attach the leading end of the sheet to the take-up apparatus 209. However, the predetermined position is not limited thereto, and may be any position set along the conveying path. As an example of a calculation method for making the determination by comparing the coordinates of the predetermined position in the conveying path with an estimated position of the leading end of the sheet, the estimated position being a position internally calculated by the CPU 605, the CPU 605 causes a detection sensor 16 for detecting the leading end or the optical sensor provided to the carriage 101 to detect the leading end of the sheet 105. The CPU 605 then determines the amount of sheet conveyed by the conveying roller 14 after the leading end has passed the sensor, on the basis of an output of the encoder for measuring the amount of rotation of the conveying roller 14. By comparing this amount conveyed, with the length of the conveying path, the length having been stored in advance, the CPU 605 can estimate the position of the leading end of the sheet 105. If the leading end of the recorded image recorded on the sheet has reached the predetermined position (Yes in S407), the process is shifted to step S408. If the leading end of the recorded image recorded on the sheet has not reached the predetermined position yet (No in S407), the process goes back to step S406 again and the scan is continued.

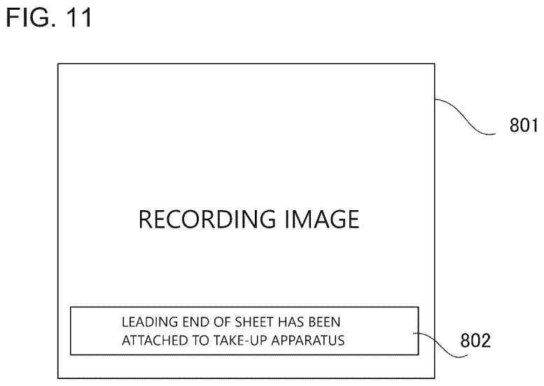

In step S408, the recording is interrupted. The timing at which the recording is interrupted is typically immediately after the leading end of the recorded image recorded on the sheet 105 has reached the predetermined position. The recording is interrupted even when the page currently being recorded is in the middle of recording. In other words, after the sheet 105 is conveyed, the recording head 102 does not scan the sheet 105, even if the recording head 102 is in the middle of the page. This control for interrupting recording when the leading end of the recorded image recorded on the sheet 105 reaches the predetermined position without having the leading end attached to the take-up apparatus 209 corresponds to first control performed by the CPU 605. The recording may also be interrupted at the time of completion of the printing of the current page. The term “page” herein means a unit of individual recording of a recorded image that is not long but that is divided into a plurality of units of recording. Such pages do not need to have constant lengths. The recording may also be interrupted at any timing that is convenient from the viewpoint of the recorded image. In step S409, processing is performed to prompt the user to attach the leading end of the sheet to the take-up apparatus 209. In this step, it is assumed that a notification is made by displaying a screen such as that illustrated in FIG. 11, but it is also possible to make the notification using other processing such as making a buzzer sound. This step may also be omitted. In step S410, it is then determined whether the attachment of the leading end of the sheet to the take-up apparatus 209 has been completed. It is assumed herein that the user makes an input of completion of the attachment on the screen, but without limitation thereto.

If the attachment of the leading end of the sheet to the take-up apparatus 209 has been completed (Yes in S410), the process is shifted to step S411. In step S411, the remaining recording operation and conveying operation for the sheet 105 are then performed until the complete recorded image is achieved. The process is then shifted to step S412. By contrast, if the attachment of the leading end of the sheet to the take-up apparatus 209 has not been completed yet (No in S410), the process is shifted to step S409.

In step S412, an operation for discharging the completed printout is performed. The sequence is then ended.

By executing the sequence, it is determined whether the leading end of the sheet has been attached to the take-up apparatus 209, and an interruption of the image recording is avoided if the leading end has been attached. Therefore, it is possible to prevent image defects such as color unevenness in the recorded image. If the leading end has not been attached, recording can be interrupted, and restarted after the leading end is attached.

### Another Processing Sequence

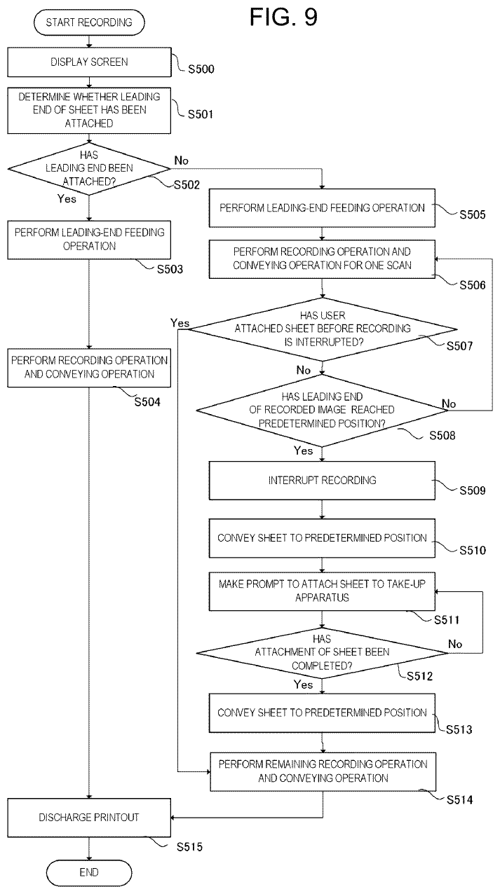

FIG. 9 is a flowchart illustrating another example of the process after image recording is started in the embodiment. Elements and operations that are the same as those in the sequence illustrated in FIG. 8 will be explained only briefly.

Upon receiving an image recording job, the recording apparatus 604 starts recording. At this time, if the sheet is of a specific type, or long printing is to be executed, the image recording may fail unless the leading end of the sheet is attached to the take-up apparatus 209. Therefore, in step S500, the user is prompted to attach the sheet 105, by displaying an input screen recommending the user to attach the leading end of the sheet to the take-up apparatus 209 before the recording is started, as illustrated in FIG. 10.

To begin with, in steps S501 to S502, it is determined whether the leading end of the sheet has been attached to the take-up apparatus 209. These steps can be performed in the same manner as steps S401 to S402 in FIG. 8. If the leading end of the sheet has been attached to the take-up apparatus 209 (Yes in S502), similarly to the case in FIG. 8 the leading-end feeding operation (step S503), the recording and conveying operation up to the point where the complete recorded image is achieved (step S504), and the discharging operation (step S515) are performed.

If the leading end of the sheet has not been attached to the take-up apparatus 209 (No in S502), the leading-end feeding operation (step S505) and the recording and conveying operation for one scan (step S506) are performed, in the same manner as steps S405 and S406 in FIG. 8.

In step S507, the CPU 605 then determines whether the user has attached the leading end of the sheet to the take-up apparatus 209 before interrupting the recording. If the user has already attached before the recording is interrupted (Yes in S507), it is not necessary to make the operation for interrupting the recording. Therefore, if it is confirmed that the leading end has been attached, the operation for interrupting the recording is omitted. This determination is made under an assumption that the user makes an input that the leading end of the sheet has been attached to the take-up apparatus 209 on the screen, for example. However, the determination method is not limited thereto. In this case, the process is shifted to step S514. The remaining recording and conveying operations are then performed.

By contrast, if the user has not attached the leading end of the sheet to the take-up apparatus 209 before interrupting the recording (No in S507), the process is shifted to step S508. In step S508, it is determined whether the leading end of the recorded image recorded on the sheet 105 has reached the predetermined position through the processing that is the same as step S407 in FIG. 8. If the leading end of the recorded image recorded on the sheet 105 has reached the predetermined position (Yes in S507), the process is shifted to step S509. By contrast, if the leading end of the recorded image recorded on the sheet 105 has not reached the predetermined position (No in S508), the process is returned to step S506 again, and the scan is continued.

In step S509, the recording is interrupted. The timing at which the recording is interrupted is made is the same as that in S408 in FIG. 8. In step S510, the processing for feeding the leading end of the sheet to a predetermined position, where the user can easily attach the leading end to the take-up apparatus 209, is performed. It is assumed herein that the predetermined position is a position where the leading end of the sheet can come into contact with the take-up apparatus 209, as an example, but is not limited thereto. This step may also be omitted.

In step S511, processing for prompting the user to attach the leading end of the sheet to the take-up apparatus 209 is performed. In this step, it is assumed that notification is made by displaying a screen such as that illustrated in FIG. 11, but it is also possible to make the notification using other processing such as making a buzzer sound. This step may also be omitted. In step S512, it is then determined whether the attachment of the leading end of the sheet to the take-up apparatus 209 has been completed. It is assumed herein that the user makes an input of completion of the attachment on the screen, but without limitation thereto.

If the attachment of the leading end of the sheet to the take-up apparatus 209 has been completed (Yes in S512), the process is shifted to step S513. In the step S513, processing for returning the leading end of the sheet to a position immediately before the execution of step S510 is performed. However, this process may not be performed. By contrast, if the attachment of the leading end of the sheet to the take-up apparatus 209 has not been completed yet (No in S512), the process is shifted to step S511.

In step S514, the remaining recording operation and conveying operation are performed for the sheet 105 until the complete recording image is achieved. The process is then shifted to step S515.

In step S515, an operation for discharging the completed printout is performed. The sequence is then ended.

By executing this sequence, it is determined whether the leading end of the sheet has been attached to the take-up apparatus 209, and if the leading end has been attached, the image recording is not interrupted. Therefore, it is possible to prevent image defects such as color unevenness in the recorded image. If the sheet 105 has not been attached, it is possible to feed the leading end of the sheet to the position where the leading end of the sheet is to be attached to the take-up apparatus 209, and to prompt to user to attach the leading end. Accordingly, the user can easily attach the sheet.

### Example of Displayed Image

FIG. 10 illustrates an example of a general input screen displayed to prompt a user to attach the leading end of the sheet to the take-up apparatus 209. A screen 701 is displayed by the CPU 605, for example, in step S400 of FIG. 8 and in step S500 of FIG. 9. The user can then press a button 702 using input means, such as a touch panel or a mouse, that is suitable for the display device. When the button 702 is pressed, it is determined that the user has completed attaching the leading end of the sheet.

FIG. 11 illustrates an example of an input screen for allowing the user to enter that the leading end of the sheet has been attached to the take-up apparatus 209 before interrupting the image recording. A screen 801 is displayed by the CPU 605 at the timing of step S409 in FIG. 8 and step S511 in FIG. 9, for example. When the button 802 is pressed, it is determined that the user has completed attaching the leading end of the sheet to the take-up apparatus 209.

FIG. 12 is an example of an input screen that is displayed when the user makes an input as to whether the leading end of the sheet has been attached. This screen 901 is displayed by the CPU 605, for example, in step S401 in FIG. 8, step S501 in FIG. 9, or as a setting on a panel while the printing is in standby. When the button 902 is pressed, it is determined that the user has completed attaching the leading end of the sheet to the take-up apparatus 209. When the button 903 is pressed, it is determined that the user has not completed attaching the leading end of the sheet to the take-up apparatus 209.

Conventionally, if the leading end of the sheet is attached to the take-up apparatus 209 before the image recording is started, the leading end of the sheet cannot be used for printing, and the sheet may be consumed wastefully. The method for addressing this issue by interrupting printing at a timing when the leading end of the sheet has reached a predetermined position and by prompting the user to attach to the take-up apparatus 209, has had a problem that printing is interrupted even when the leading end of the sheet has already been attached. This is because the recording apparatus 604 has not been configured to determine whether the sheet 105 has been attached to the take-up apparatus 209, and such an interruption may result in printouts with image defects such as color unevenness.

By contrast, with the configuration according to the embodiment of the present disclosure, at the timings such as the timings at which recording is started, and at which the leading end of the sheet has reached the predetermined position of the conveying path, it is determined whether the leading end of the sheet has been attached to the take-up apparatus 209, as described above. The recording can then be interrupted if it is determined that the leading end of the sheet has not been attached to the take-up apparatus 209. If the leading end has already been attached, recording is continued without making an interruption, so that it is possible to prevent image defects such as color unevenness accompanying such an interruption. It is also possible to prompt a user to attach the leading end of the sheet.

According to the present disclosure, in recording apparatuses including a take-up apparatus configured to wind a sheet by having the leading end of the sheet attached thereto, it is possible to prevent image defects caused by such interruptions in image recording.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-139731, filed Aug. 21, 2024, and Japanese Patent Application No. 2025-112313, filed Jul. 2, 2025, which are hereby incorporated by reference herein in their entirety.

What is claimed is:

1. A recording apparatus recording an image onto a recording medium wound as a roll, the recording apparatus comprising:
a conveying unit configured to convey, along a conveying path, the recording medium pulled out from the roll;
a recording unit disposed along the conveying path and configured to record an image onto the recording medium;
a take-up unit configured to wind the recording medium onto which the image has been recorded; and
a control unit configured to execute first control of momentarily interrupting recording after starting recording of the image without having a leading end of the recording medium attached to the take-up unit, with a leading end of a recorded image on the recording medium having reached a predetermined position in the conveying path, and second control of continuing the recording when the leading end of the recorded image on the recording medium has reached the predetermined position, with the leading end of the recording medium having attached to the take-up unit.

2. The recording apparatus according to claim 1, wherein the leading end of the recorded image on the recording medium includes a margin.

3. The recording apparatus according to claim 1, wherein in a case where a plurality of images are recorded after recording of the image has been started, the leading end of the image is the leading end of the most downstream image.

4. The recording apparatus according to claim 1, wherein the control unit is configured to restart the recording of the image after the leading end is attached to the take-up unit.

5. The recording apparatus according to claim 1, wherein the control unit is configured to record the image without momentarily interrupting the recording when the leading end has been attached to the take-up unit.

6. The recording apparatus according to claim 1, wherein the control unit is configured to determine whether the leading end has been attached to the take-up unit before starting the recording of the image, and, even determination has been made that the leading end has not been attached, the image is recorded without momentary interruption, when the leading end is attached to the take-up unit before the leading end reaches the predetermined position.

7. The recording apparatus according to claim 1, further comprising an input unit configured to receive an input of a user, wherein
the control unit is configured to determine whether the leading end has been attached to the take-up unit, based on an input via the input unit.

8. The recording apparatus according to claim 1, wherein the control unit is configured to determine whether the leading end has been attached to the take-up unit, based on a tension value resultant of causing the take-up unit to wind the recording medium.

9. The recording apparatus according to claim 6, wherein the control unit is configured to determine that the recording medium has been attached to the take-up unit when the tension value is at least a predetermined threshold, and the tension value takes a different value depending on a type of the recording medium.

10. The recording apparatus according to claim 1, wherein the control unit is configured to prompt a user to attach the leading end to the take-up unit before starting recording the image.

11. The recording apparatus according to claim 1, wherein the control unit is configured to prompt a user to attach the leading end to the take-up unit when the recording of the image is momentarily interrupted.

12. The recording apparatus according to claim 1, wherein the predetermined position along the conveying path is a position where the leading end is attachable to the take-up unit.

13. The recording apparatus according to claim 1, wherein the control unit is configured to momentarily interrupt the recording the image, immediately after the leading end has reached the predetermined position.

14. The recording apparatus according to claim 1, wherein
the image to be recorded onto a recording medium includes a plurality of recording units, and
the control unit is configured to make a momentary interruption upon completion of recording based on the recording unit, the unit being recorded at a point of time at which the leading end has reached the predetermined position.

15. The recording apparatus according to claim 1, wherein the control unit is configured to, when the recording of the image interrupted momentarily, convey the leading end of the recording medium to a position where the leading end is attachable to the take-up unit.
